(19) United States
(12) Patent Application Publication
(10) Pub. No.: US 2023/0400811 A1
(43) Pub. Date: Dec. 14, 2023

(54) HOLOGRAM PROFILE OPTIMIZATION METHOD, HOLOGRAM PROFILE GENERATION DEVICE, AND HOLOGRAPHIC DISPLAY DEVICE TO WHICH HOLOGRAM PROFILE OPTIMIZATION METHOD IS APPLIED

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Seokil MOON, Suwon-si (KR); Dongheon YOO, Seoul (KR); Changkun LEE, Suwon-si (KR); Byoungho LEE, Seoul (KR); Minseok CHAE, Seoul (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 18/116,528

(22) Filed: Mar. 2, 2023

(30) Foreign Application Priority Data
Jun. 14, 2022 (KR) 10-2022-0072432

(51) Int. Cl. G03H 1/32; G03H 1/26; G06T 7/168; G06T 5/00

(52) U.S. Cl. CPC G03H 1/32; G03H 1/2645; G06T 7/168; G06T 5/002; G03H 2226/02; G03H 2225/32; G03H 2001/2655; G06T 2207/20021; G06T 2200/24; G06T 2207/20048

(57) ABSTRACT

A hologram profile optimization method includes: setting a first hologram profile as a variable; and performing an optimization cycle a predetermined number of times, wherein the optimization cycle includes encoding the first hologram profile into a binary hologram profile by using an ApproxSign function; calculating a field value of a holographic image on a display surface for the binary hologram profile, considering high-order diffraction term noise of the holographic image by using a tiling function; calculating an intensity of the holographic image on the display surface; calculating a loss function value based on a difference between the intensity of the holographic image and an intensity of a target image; and updating the first hologram profile to a second hologram profile based on the loss function value.

### CROSS-REFERENCE TO RELATED APPLICATION

This application is based on and claims priority under 35 U.S.C. § 119 to Korean Patent Application No. 10-2022-0072432, filed on Jun. 14, 2022 in the Korean Intellectual Property Office, the disclosure of which is incorporated by reference herein in its entirety.

### BACKGROUND

### 1. Field

The disclosure relates to a hologram profile optimization method for noise filtering, and a hologram profile generation device and a hologram display device, to which the hologram profile optimization method is applied.

### 2. Description of Related Art

A holographic display device is one of the promising three-dimensional (3D) display technologies. Holographic display devices are said to be a natural 3D display method, since they can copy and reproduce complex wavefronts of light present in nature. Recently, studies for implementing a head-mounted display (HMD) using a holographic display device have been actively conducted.

To commercialize a holographic HMD, there are tasks to be solved, such as high resolution, a wide field of view, and a wide eye-box. In addition, the holographic display device should also be configured in a small size for a user to wear. Because optical devices constituting the holographic display device in the related art occupy a large volume, it may not be easy to apply the holographic display device to an HMD. Particularly, because the holographic display device generates noise together with an image and thus an optical noise filtering system is required, the large size of an optical noise filtering system may hinder miniaturization of the holographic display device.

### SUMMARY

The disclosure provides a hologram profile optimization method capable of replacing an optical noise filtering system and a hologram profile generation device using a hologram profile optimization method.

The disclosure provides a holographic display device, in which the optical noise filtering system is omitted.

Additional aspects will be set forth in part in the description which follows and, in part, will be apparent from the description, or may be learned by practice of embodiments of the disclosure.

In accordance with an aspect of the disclosure, a hologram profile optimization method includes setting a first hologram profile as a variable; and performing an optimization cycle a predetermined number of times, wherein the optimization cycle includes: encoding the first hologram profile into a binary hologram profile by using an ApproxSign function; calculating a field value of a holographic image on a display surface for the binary hologram profile, considering high-order diffraction term noise of the holographic image by using a tiling function; calculating an intensity of the holographic image on the display surface; calculating a loss function value based on a difference between the intensity of the holographic image and an intensity of a target image; and updating the first hologram profile to a second hologram profile based on the loss function value.

The encoding of the first hologram profile into the binary hologram profile may include calculating the binary hologram profile by using Formula 1 below:

h=sign(Aᵥ cos(φᵥ)+eps) [Formula 1]
wherein Aᵥ is an initial amplitude profile, φᵥ is an initial phase profile, eps is a small value, and a sign function is the ApproxSign function.

The calculating of the field value of the holographic image on the display surface for the binary hologram profile may include converting the binary hologram profile into spatial frequency information by using a second-order Fourier transform, and tiling the spatial frequency information by using the tiling function.

The calculating of the field value of the holographic image on the display surface for the binary hologram profile may include adjusting the spatial frequency information by using Formula 2 below so that physically proper energy distribution is obtained:

S(fₓ,f_{y})=sinc(ppₓfₓ)sinc(ppₓf_{y}) [Formula 2]
wherein ppₓ is an interval between unit pixels of a binary phase spatial optical modulator, fₓ is the spatial frequency information in an x direction, and f_{y} is the spatial frequency information in a y direction.

The calculating of the field value of the holographic image on the display surface for the binary hologram profile may include calculating a propagation function value of the holographic image by using Formula 3 below:

$${P}_{d} ( {f}_{x} , {f}_{y} ) = \{ \begin{matrix}{e}^{- i \frac{2 π}{λ} d \sqrt{1 - {( λ {f}_{x} )}^{2} - {( λ {f}_{y} )}^{2}}} , & if \sqrt{{f}_{x}^{2} + {f}_{y}^{2}} < \frac{1}{λ} \\ 0 & otherwise\end{matrix} \qquad [ Formula 3 ]$$

wherein d is a propagation distance, A is a center frequency of a used light beam, fₓ is the spatial frequency information in the x direction, and f_{y} is the spatial frequency information in the y direction.

The calculating of the field value of the holographic image on the display surface for the binary hologram profile may include calculating the field value of the holographic image by using Formula 4 below:

z=p⁻¹(P_{d}(fₓ,f_{y})S(fₓ,f_{y})T(F(h)) [Formula 4]
wherein h is the encoded binary hologram profile, F is a two-dimensional Fourier transform, T is the tiling function, fₓ is spatial frequency information in an x direction, f_{y} is the spatial frequency information in a y direction, S is a sinc function, Pd is a propagation function, and F⁻¹ is a two-dimensional inverse Fourier transform.

The calculating of the intensity of the holographic image on the display surface may include calculating the intensity of the holographic image by using Formula 5 below:

I=|z|² [Formula 5]
wherein z is the field value of the holographic image on the display surface.

The calculating the loss function value based on the difference between the intensity of the holographic image and the intensity of the target image may include calculating the loss function value by using Formula 6 below:

L=Σ(I−Î)² [Formula 6]
wherein I is the intensity of the holographic image, and Î is the intensity of the target image.

The updating of the first hologram profile to the second hologram profile based on the loss function value may include updating the first hologram profile to the second hologram profile by using Formula 7 below:

$${A}_{v , n + 1} ← {A}_{v , n} - \frac{\partial L}{\partial ( {A}_{v , n} )} \\ {φ}_{v , n + 1} ← {φ}_{v , n} - \frac{\partial L}{\partial ( {φ}_{v , n} )} \qquad [ Formula 7 ]$$

wherein φ_{v,n} is a current phase profile, φ_{v,n+1} is an updated phase profile, A_{v,n} is a current amplitude profile, A_{v,n+1} is an updated amplitude profile, and L is a loss function.

In accordance with an aspect of the disclosure, a hologram profile generation device includes a processor configured to generate a hologram profile by using a hologram profile optimization method; a memory configured to store the hologram profile generated by the processor; and a user interface configured to receive an instruction of a user and display a usage state, wherein the hologram profile optimization method includes setting a first hologram profile as a variable; and performing an optimization cycle a predetermined number of times, wherein the optimization cycle includes: encoding the first hologram profile into a binary hologram profile by using an ApproxSign function; calculating a field value of a holographic image on a display surface for the binary hologram profile, considering high-order diffraction term noise of the holographic image by using a tiling function; calculating an intensity of the holographic image on the display surface; calculating a loss function value based on a difference between the intensity of the holographic image and an intensity of a target image; and updating the first hologram profile to a second hologram profile based on the loss function value.

The encoding of the first hologram profile into the binary hologram profile may include calculating the binary hologram profile by using Formula 1 below:

h=sign(Aᵥ cos(φᵥ)+eps) [Formula 1]
wherein Aᵥ is an initial amplitude profile, φᵥ is an initial phase profile, eps is a small value, and a sign function is the ApproxSign function.

The calculating of the field value of the holographic image on the display surface for the binary hologram profile may include converting the binary hologram profile into spatial frequency information by using a second-order Fourier transform; and tiling the spatial frequency information by using the tiling function.

The calculating of the field value of the holographic image on the display surface for the binary hologram profile may include adjusting the spatial frequency information by using Formula 2 below so that physically proper energy distribution is obtained:

S(fₓ,f_{y})=sinc(ppₓfₓ)sinc(ppₓf_{y}) [Formula 2]
wherein ppₓ is an interval between unit pixels of a binary phase spatial optical modulator, fₓ is the spatial frequency information in an x direction, and f_{y} is the spatial frequency information in a y direction.

The calculating of the field value of the holographic image on the display surface for the binary hologram profile may include calculating a propagation function value of the holographic image by using Formula 3 below:

$${P}_{d} ( {f}_{x} , {f}_{y} ) = \{ \begin{matrix}{e}^{- i \frac{2 π}{λ} d \sqrt{1 - {( λ {f}_{x} )}^{2} - {( λ {f}_{y} )}^{2}}} , & if \sqrt{{f}_{x}^{2} + {f}_{y}^{2}} < \frac{1}{λ} \\ 0 & otherwise\end{matrix} \qquad [ Formula 3 ]$$

wherein d is a propagation distance, A is a center frequency of a used light beam, fₓ is the spatial frequency information in the x direction, and f_{y} is the spatial frequency information in the y direction.

The calculating of the field value of the holographic image on the display surface for the binary hologram profile may include calculating the field value of the holographic image by using Formula 4 below:

z=p⁻¹(P_{d}(fₓ,f_{y})S(fₓ,f_{y})T(F(h)) [Formula 4]
wherein h is the encoded binary hologram profile, F is a two-dimensional Fourier transform, T is the tiling function, fₓ is spatial frequency information in the x direction, f_{y} is spatial frequency information in the y direction, S is a sinc function, Pd is a propagation function, and F⁻¹ is a two-dimensional inverse Fourier transform.

In accordance with an aspect of the disclosure, a holographic display device includes a light source configured to provide light, a spatial optical modulator configured to generate a holographic image by refracting the light; and a processor configured to convert a first hologram profile to a second hologram profile by using a hologram profile optimization method, and provide the second hologram profile to the spatial optical modulator, wherein the hologram profile optimization method includes: setting the first hologram profile as a variable; and performing an optimization cycle a predetermined number of times, wherein the optimization cycle includes: encoding the first hologram profile into a binary hologram profile by using an ApproxSign function; calculating a field value of the holographic image on a display surface for the binary hologram profile, considering high-order diffraction term noise of the holographic image by using a tiling function; calculating an intensity of the holographic image on the display surface; calculating a loss function value based on a difference between the intensity of the holographic image and an intensity of a target image; and updating the first hologram profile to the second hologram profile based on the loss function value.

The spatial optical modulator may include a binary phase spatial optical modulator.

The processor may polymerize a plurality of holographic images generated by performing a plurality of random phase modulations on the second hologram profile.

The encoding of the first hologram profile into the binary hologram profile may include calculating the binary hologram profile by using Formula 1 below:

h=sign(Aᵥ cos(φᵥ)+eps) [Formula 1]

wherein Aᵥ is an initial amplitude profile, φᵥ is an initial phase profile, eps is a small value, and a sign function is the ApproxSign function.

The calculating of the field value of the holographic image on the display surface for the binary hologram profile may include converting the binary hologram profile into spatial frequency information by using a second-order Fourier transform, and tiling the spatial frequency information by using the tiling function.

The calculating of the field value of the holographic image on the display surface for the binary hologram profile may include adjusting the spatial frequency information by using Formula 2 below so that physically proper energy distribution is obtained:

S(fₓ,f_{y})=sinc(ppₓfₓ)sinc(ppₓf_{y}) [Formula 2]
wherein ppₓ is an interval between unit pixels of a binary phase spatial optical modulator, fₓ is the spatial frequency information in an x direction, and f_{y} is the spatial frequency information in a y direction.

The calculating of the field value of the holographic image on the display surface for the binary hologram profile may include calculating a propagation function value of the holographic image by using Formula 3 below:

$${P}_{d} ( {f}_{x} , {f}_{y} ) = \{ \begin{matrix}{e}^{- i \frac{2 π}{λ} d \sqrt{1 - {( λ {f}_{x} )}^{2} - {( λ {f}_{y} )}^{2}}} , & if \sqrt{{f}_{x}^{2} + {f}_{y}^{2}} < \frac{1}{λ} \\ 0 & otherwise\end{matrix} \qquad [ Formula 3 ]$$

wherein d is a propagation distance, A is a center frequency of a used light beam, fₓ is the spatial frequency information in the x direction, and f_{y} is the spatial frequency information in the y direction.

The calculating of the field value of the holographic image on the display surface for the binary hologram profile may include calculating the field value of the holographic image by using Formula 4 below:

z=p⁻¹(P_{d}(fₓ,f_{y})S(fₓ,f_{y})T(F(h)) [Formula 4]
wherein h is the encoded binary hologram profile, F is a two-dimensional Fourier transform, T is the tiling function, fₓ is the spatial frequency information in the x direction, f_{y} is the spatial frequency information in the y direction, S is a sinc function, Pd is a propagation function, and F⁻¹ is a two-dimensional inverse Fourier transform.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of a holographic display device using a 2-f system;

FIG. 2 is a schematic diagram of a holographic display device, according to an embodiment;

FIGS. 3 and 4 are diagrams for describing a time multiplexing method;

FIG. 5 is a diagram for describing a viewing window formed by a holographic display device including a binary phase spatial light modulator;

FIG. 6 is a block diagram illustrating a hardware configuration of a hologram profile generation device, according to an embodiment;

FIG. 7 is a schematic diagram illustrating the holographic display device of FIG. 2 to explain a hologram profile optimization method;

FIG. 8 is a flowchart of a hologram profile optimization method;

FIGS. 9A and 9B are a sign function and a derivative of the sign function, respectively, according to embodiments;

FIG. 10A and FIG. 10B are a sign function and a derivative of the sign function according to embodiments;

FIG. 11A and FIG. 11B are a sign function and a derivative of the sign function according to embodiments; and

FIGS. 12 and 13 are diagrams for explaining the effects of a hologram profile optimization method and a time multiplexing method.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, embodiments are merely described below, by referring to the figures, to explain aspects. As used herein, the term “and/or” includes any and all combinations of one or more of the associated listed items. Expressions, such as “at least one of,” when preceding a list of elements, modify the entire list of elements and do not modify the individual elements of the list.

Hereinafter, a retina projection display device will be described in detail with reference to the accompanying drawings. Like reference numerals in the drawings denote like components, and sizes of components in the drawings may be exaggerated for convenience of explanation.

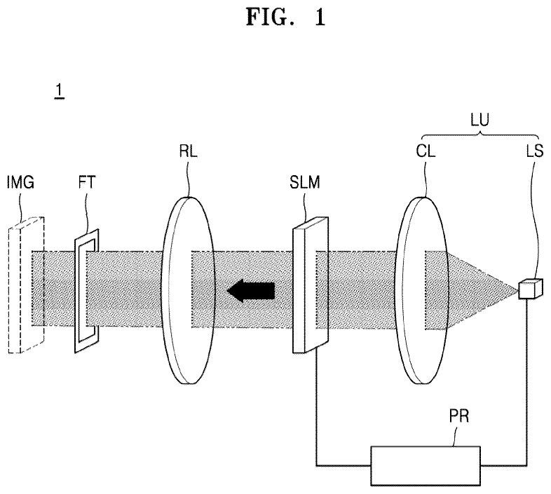

FIG. 1 is a schematic diagram of a holographic display device 1 using a 2-f system.

Referring to FIG. 1, the holographic display device 1 using a 2-f system may include a light source unit LU, a spatial light modulator SLM, a relay lens RL, a Fourier filter FT, and a processor PR. In this case, the relay lens RL and the Fourier filter FT may constitute an optical noise filtering, and may be referred to as the 2-f system. The spatial light modulator SLM may receive a hologram profile from the processor PR, receive light from the light source unit LU including a light source LS and a collimator lens CL, and reproduce a holographic image. When the holographic image output from the spatial light modulator SLM passes through the relay lens RL, a Fourier plane may be formed on a path on an emission surface side of the relay lens RL. The holographic image may be separated into an area in which noise appears on the Fourier plane, and an area in which a signal appears. In this case, the noise may include direct current (DC) term noise, high-order diffraction term noise, and conjugate image noise, and when these pieces of noise are removed from the holographic image, only the signal image IMG may be obtained. The Fourier filter FT may remove noise by covering a region where there is noise on the Fourier surface.

Because the 2-f system includes the relay lens RL for noise removal, an additional optical path that is twice a focal length of the relay lens RL may be required. Accordingly, in the holographic display device 1 designed by using this feature, the 2-f system may occupy a large portion of the volume of the holographic display device 1, and thus, the size of the entire system may be increased.

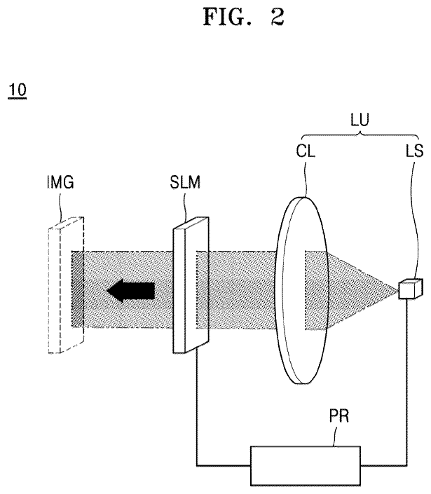

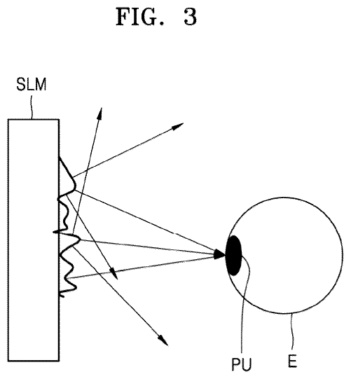

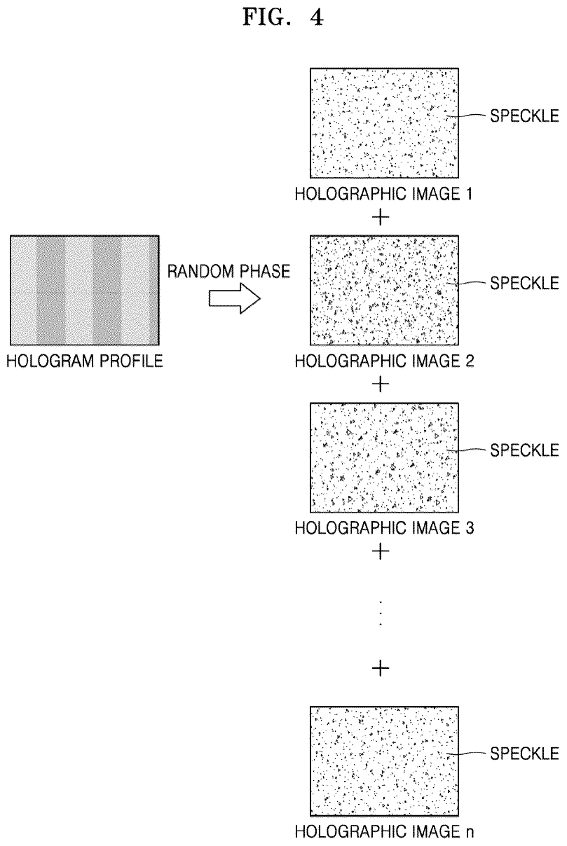

FIG. 2 is a schematic diagram of a holographic display device 10, according to an example embodiment. FIGS. 3 and 4 are diagrams for describing a time multiplexing method.

Referring to FIG. 2, the holographic display device 10 according to an example embodiment of the disclosure may include the light source unit LU, the spatial light modulator SLM, and the processor PR. The holographic display device 10 illustrated in FIG. 2 may remove noise by using a temporal multiplexing method and the hologram profile optimization method to be described below, instead of removing noise by using an optical noise filtering system (that is, the 2-f system). In other words, because the 2-f system is omitted from the holographic display device 10 of the disclosure illustrated in FIG. 2, the size of the entire system may be reduced.

The light source unit LU according to an example embodiment may include the light source LS and the collimator lens CL. The light source LS may include a laser diode to provide light having high coherence to the spatial light modulator SLM. However, it may be also possible to use a light-emitting diode as the light source LS because light provided by the light source LS may be sufficiently diffracted and modulated by the spatial light modulator SLM when the light provided by the light source LS has a level of coherence equal to or higher than a certain level of spatial coherence. In addition, the light source LS may have a light source array of red color, green color, and blue color, and may also implement a color hologram image by red/green/blue (RGB) time division driving. For example, the light source LS may include a plurality of laser diodes or an array of light-emitting diodes. In addition, the light source LS may use any other light source as long as the light source emits light having spatial coherence in addition to the laser diodes and the light-emitting diodes.

The light source unit LU may illuminate collimated parallel light. For example, the light source unit LU may collimate light emitted from the light source LS into parallel light by using the collimator lens CL.

The spatial light modulator SLM may form a hologram pattern, on a light modulation surface, according to the hologram profile provided by the processor PR. Light incident on the spatial light modulator SLM may be converted into the holographic image by the holographic pattern. In an embodiment of FIG. 2, although the spatial light modulator SLM is illustrated as a transmissive spatial light modulator, the spatial light modulator SLM may also be implemented as a reflective spatial light modulator.

The spatial light modulator SLM according to an example embodiment may be a binary phase spatial light modulator SLM, which is implemented such that a phase signal of each pixel is represented only by two types of signals, that is, 0 and 1. The binary phase spatial light modulator SLM may not express a complex number, and may express only real numbers by using brightness adjustment of a light source corresponding to each pixel.

For example, the binary phase spatial light modulator SLM may be implemented as a digital micromirror device (DMD), a liquid crystal on silicon (LCoS), a ferroelectric liquid crystal on silicon (FLCoS), etc.

By controlling the intensity of a light source in each pixel by using the light source LS and the binary phase spatial light modulator SLM, the holographic display device 10 may not output light for a pixel having a binary value of 0 in the hologram profile, but may output a holographic image by forming a holographic pattern in a form of outputting light for a pixel having a binary value of 1 in the hologram profile.

Due to this operation, the binary phase spatial optical modulator SLM may have an advantage of a fast driving speed because an amount of holographic profile processing computations is significantly reduced, but the binary phase spatial optical modulator SLM may have a disadvantage of low reproducibility of the holographic image, compared to the target image (or, the original image). Accordingly, the holographic display device 10 implemented as the binary phase spatial light modulator SLM may be driven by applying the time multiplexing method thereto.

Referring to FIGS. 2 and 3, the processor PR may perform a plurality of random phase modulations on one input hologram profile. In this case, the hologram profile may correspond to a hologram profile (or a second hologram profile) to be updated by a hologram profile optimization method to be described below.

The binary phase spatial light modulator SLM may diffract light according to the modulated hologram profile. Light emitted by the binary phase spatial light modulator SLM may be randomly scattered according to a random phase. A portion of the randomly scattered light may not pass through the pupil PU of a user's eye E.

Accordingly, some area of the holographic image may look dark as a plurality of holographic images illustrated on the right side of FIG. 4, or speckle noise recognized as small dots may be generated in the holographic image.

The time multiplexing method may include an operation of generating a plurality of holographic images by performing a plurality of random phase modulations on one hologram profile (or the second hologram profile), and an operation of polymerizing the generated plurality of holographic images into one holographic image.

Because the speckle is randomly generated by random phase modulation, positions of a speckle included in a first holographic image, a speckle included in a second holographic image, a speckle included in a third holographic image, through an n^{th} holographic image may be different. Accordingly, when one holographic image is generated by polymerizing the first through n^{th} holographic images, distribution of the speckles included in the polymerized holographic image may be uniform. Due to this reason, the user may not recognize the speckle included in the polymerized holographic image as noise.

According to an example embodiment, the processor PR may perform random phase modulation on the hologram profile for each frame of the binary phase spatial light modulator SLM driven at a particular driving frequency. For example, when the driving frequency of the holographic display device 10 is about 60 Hz, the processor PR may perform ten random phase modulations about every 1/60 sec. In other words, the driving frequency of the binary phase spatial light modulator SLM may be about 600 Hz.

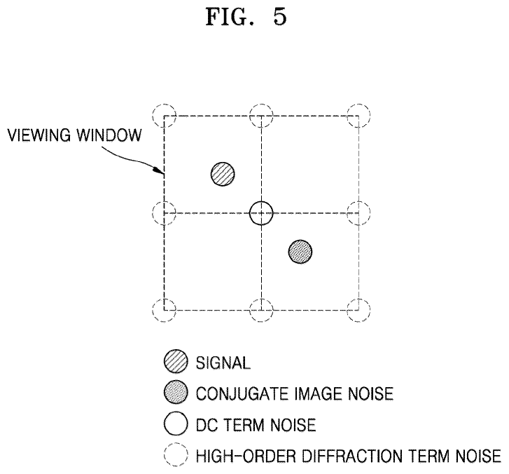

FIG. 5 is a diagram for describing a viewing window formed by the holographic display device 1 including the binary phase spatial light modulator SLM.

Referring to FIG. 5, when a hologram profile for reproducing a holographic image is represented by the binary phase spatial light modulator SLM, a process of converting complex information into intensity of light may be essential, and in this case, information loss may inevitably occur.

Due to this reason, as illustrated in FIG. 5, DC term noise, high-order diffraction term noise, and conjugate image noise as well as signals to be displayed in the viewing window may be generated. Accordingly, an area, in which the user may actually normally view, may be a very narrow area excluding noise in the viewing window.

The holographic display device 1 illustrated in FIG. 1 may remove these pieces of noise by using the optical noise filtering system (that is, the 2-f system). On the other hand, because the holographic display device 10 of the disclosure excludes the optical noise filtering system illustrated in FIG. 2, these pieces of noise may be removed by providing an optimized hologram profile (or, the second hologram profile), that takes into consideration noise components, to the binary phase spatial light modulator SLM.

The optimized hologram profile (or, the second hologram profile) may be calculated by using the hologram profile optimization method. The hologram profile optimization method may encode an initial hologram profile into a binary hologram profile, convert the encoded binary hologram profile to spatial frequency information by using a Fourier transform, tile the converted spatial frequency information to model high-order diffraction noise generated by a diffraction grating, adjust the spatial frequency information to have a physically proper energy distribution, calculate a difference between intensity of a holographic image restored after restoring intensity of the holographic image on a display surface and intensity of a target image, and calculate an optimized hologram profile capable of minimizing the difference by using a gradient descent method.

According to an example embodiment, the hologram profile optimization method may be performed by the processor PR of the holographic display device 10 of the disclosure illustrated in FIG. 2. In this case, the processor PR may calculate the optimized hologram profile (or, the second hologram profile) considering the specification of the holographic display device 10. For example, the specification of the holographic display device 10 may include an interval between unit pixels of the spatial light modulator SLM, a center wavelength of light emitted by the light source LS, a propagation distance between the spatial light modulator SLM and the display surface, etc.

However, the disclosure is not limited thereto, and the hologram profile optimization method may also be performed by a hologram profile generation device to be described below. In this case, the hologram profile generation device may calculate the optimized hologram profile (or, the second hologram profile) considering the specification of the holographic display device to provide the hologram profile.

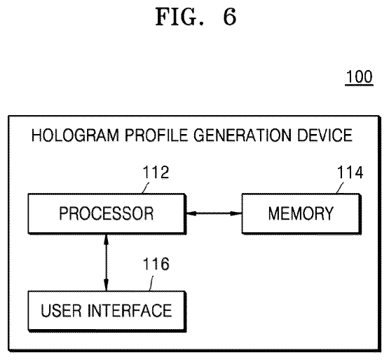

Hereinafter, the hologram profile optimization method is described in more detail with reference to FIGS. 6 through 11B.

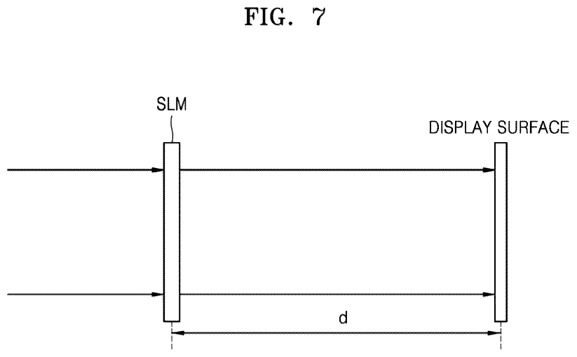

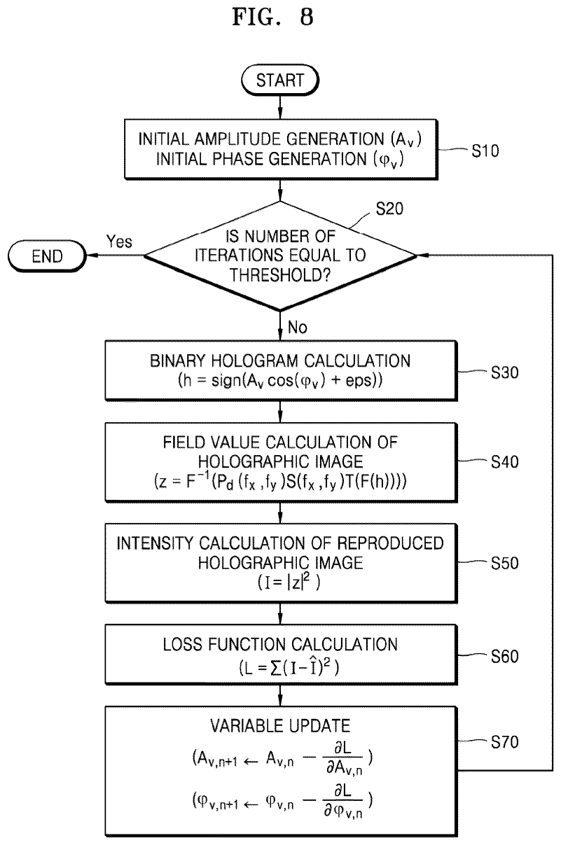

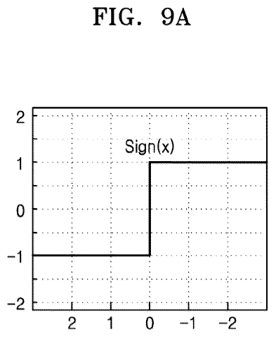

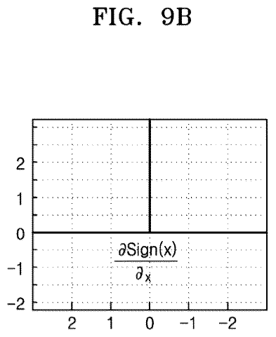

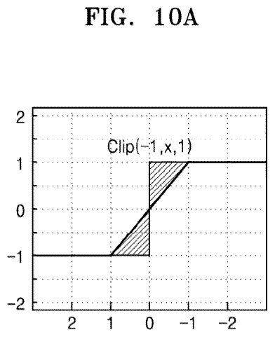

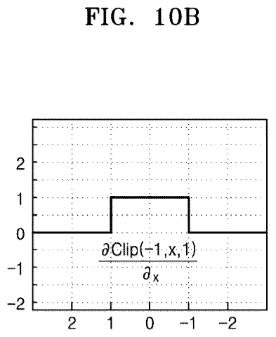

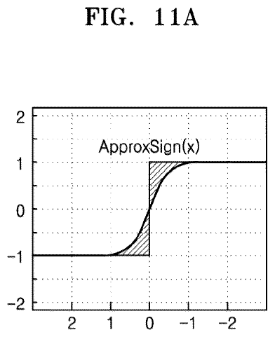

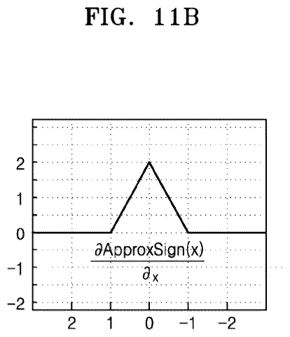

FIG. 6 is a block diagram illustrating a hardware configuration of a hologram profile generation device 100, according to an example embodiment. FIG. 7 is a schematic diagram illustrating the holographic display device 10 of FIG. 2 to explain the hologram profile optimization method. FIG. 8 is a flowchart of a hologram profile optimization method. FIGS. 9A and 9B are a sign function and a derivative function, respectively, according to example embodiments. FIG. 10A and FIG. 10B are a sign function and a derivative function according to other embodiments, respectively. FIG. 11A and FIG. 11B are a sign function and a derivative function according to other embodiments, respectively.

Referring to FIG. 6, the hologram profile generation device 100 may include a processor 112, a memory 114, and a user interface 116. Only components related to embodiments are illustrated in the hologram profile generation device 100 illustrated in FIG. 6. Accordingly, it should be obvious to those of skill in the art that the hologram profile generation device 100 may further include other general-purpose components in addition to the components illustrated in FIG. 6.

The processor 112 may correspond to a processor provided in various types of computing devices, such as a personal computer (PC), a server device, a television (TV), a mobile device (smartphone, tablet device, or the like), an embedded device, an autonomous vehicle, a wearable device, an augmented reality (AR) device, an Internet of Things (IoT) device, etc. For example, the processor 112 may correspond to a processor, such as a central processing unit (CPU), a graphics processing unit (GPU), an application processor (AP), a neural processing unit (NPU), or the like, but is not limited thereto.

The processor 112 may perform overall functions for controlling the hologram profile generation device 100 provided with the processor 112. The processor 112 may overall control the hologram profile generation device 100 by executing programs stored in the memory 114. For example, when the hologram profile generation device 100 is provided in the holographic display device (refer to 10 of FIG. 2), the processor 112 may control display of the holographic image by using the light source unit (refer to LU in FIG. 2) and the spatial light modulator SLM by controlling an image processing of the hologram profile generation device 100.

The processor 112 may include, for example, a control unit for overall controlling hologram profile processing operations, and a plurality of processing cores for performing the Fourier transform operation (that is, a fast Fourier transform (FFT) operation). Because the Fourier transform operation such as the FFT operation corresponds to operations that account for a large proportion of hologram profile processing operations, the processor 112 may accelerate hologram profile processing by using parallel processing of a plurality of processing cores. Each of the plurality of processing cores may be implemented as a circuit logic, in which, for example, a shift register, a multiplier, or the like are combined for performing the FFT operation. The number of processing cores in the processor 112 may be variously changed considering various factors, such as performance of the processor 112, resolution of the spatial light modulator SLM, and resolution of the holographic image. A plurality of FFT cores may perform FFT operations in parallel for performing a double stage Fourier transform (primary Fourier transform and secondary Fourier transform).

The memory 114 may be hardware for storing various types of data processed by the processor 112, and for example, the memory 114 may store hologram profile data processed by the processor 112 and hologram profile data to be processed.

Furthermore, the memory 114 may store various applications to be driven by the processor 112, for example, a hologram profile generation application, a web browsing application, a video application, etc.

The memory 114 may include at least one of a volatile memory and a nonvolatile memory. The non-volatile memory may include read only memory (ROM), programmable ROM (PROM), electrically programmable ROM (EPROM), electrically erasable and programmable ROM (EEPROM), a flash memory, etc. The volatile memory may include dynamic RAM (DRAM), static RAM (SRAM), synchronous DRAM (SDRAM), phase-change RAM (PRAM), magnetic RAM (MRAM), resistive RAM (RRAM), ferroelectric RAM (FeRAM), etc. In an embodiment, the memory 114 may be a hard disk drive (HDD), a solid state drive (SSD), a compact flash (CF) memory, a secure digital (SD) memory, a micro secure digital Secure digital) memory, an extreme digital (xD) memory, or a memory stick.

The user interface 116 may include a device that receives a user's command or displays a usage state of the hologram profile generation device 100. For example, the user interface 116 may include a physical button, a touch screen, etc. In addition, the user interface 116 may include a port or the like for exchanging input/output with an external electronic device.

Referring to FIG. 7, the binary phase spatial light modulator SLM may form a hologram pattern on a light modulation surface according to a hologram profile provided by the processor (refer to PR in FIG. 2). Light incident on the binary spatial light modulator SLM may be converted into the holographic image by the hologram pattern. In this case, the holographic image may be displayed on the display surface apart from the light modulation surface of the binary phase spatial light modulator SLM by a first distance d.

Referring to FIG. 8, the hologram profile optimization method according to an example embodiment may include setting an initial hologram profile (or, the first hologram profile) as a variable to be optimized (S10), determining whether an optimization cycle is equal to a preset threshold (S20), encoding the initial hologram profile (or, the first hologram profile) into a binary hologram profile h (S30), calculating a field value z on a display surface with respect to the encoded binary hologram profile h (S40), calculating intensity I of a holographic image on the display surface (S50), calculating a loss function value L based on a difference between intensity I of the restored holographic image and intensity of a target image Î (S60), and updating the initial hologram profile (or, the first hologram profile) to a final hologram profile (or, the second hologram profile) based on the loss function value L (S70).

In operation S10 of setting the initial hologram profile (or, the first hologram profile) as a variable to be optimized, the processor 112 may generate an initial amplitude Av and an initial phase φv of the initial hologram profile (or the first hologram profile) and set them as variables to be optimized.

In operation S20 of determining whether the optimization cycle is equal to a preset threshold value, the processor 112 may determine whether a series of processes (that is, an optimization cycle) for updating the hologram profile reaches the preset threshold value. In other words, the optimization cycle is performed a predetermined number of times equal to the preset threshold value. For example, the threshold may be about 500. When the optimization cycle is less than the preset threshold value, the processor 112 may perform the optimization cycle once more. On the other hand, when the optimization cycle is equal to the preset threshold value, the processor 112 may stop the optimization cycle, and set the calculated variable to a final optimized hologram file (or, the second hologram profile).

In operation S30 of encoding the initial hologram profile (or, the first hologram profile) to the binary hologram profile h, the processor 112 may encode the initial hologram profile (or, the first hologram profile) to the binary hologram profile h by using Formula 1 below.

h=sign(Aᵥ cos(φᵥ)+eps) [Formula 1]

In this case, Aᵥ may be an initial amplitude profile, φᵥ may be an initial phase profile, eps may be an infinitesimal value (for example, a small value such as 1e⁻⁸), and a sign function may be an ApproxSign function (see, e.g., FIG. 11A).

The sign function shown in FIG. 9A may be a traditionally used binarization function. However, as illustrated in FIG. 9B, since the derivative of the sign function is a delta function, it may be difficult to use the derivative of the sign function as a derivative for using the gradient descent method. Thus, by using a clip function illustrated in FIG. 10A in the related art, the Square function illustrated in FIG. 10B may be used as a derivative function. However, the binary hologram profile h of the disclosure may use a triangular function illustrated in FIG. 11B as a derivative function by using the ApproxSign function illustrated in FIG. 11A for more accurate modeling. When the triangular function illustrated in FIG. 11B is used as a derivative function, a peak signal-to-noise ratio (PSNR) of the holographic image may be improved by about 0.1 to about 0.2 compared to the case of using the Square function illustrated in FIG. 10B as a derivative function in the related art.

Operation S40 of calculating the field value z on the display surface for the encoded binary hologram profile h may include converting the encoded binary hologram profile h into spatial frequency information by using a second-order Fourier transform, tiling the converted spatial frequency information for modeling the high-order diffraction noises generated by a diffraction grating, and adjusting the spatial frequency information to obtain physically proper energy distribution.

In operation S40 of calculating the field value z of the holographic image on the display surface with respect to the encoded binary hologram profile h, the processor 112 may calculate the field value z of the holographic image on the display surface by using Formula 2 below.

S(fₓ,f_{y})=sinc(ppₓfₓ)sinc(ppₓf_{y}) [Formula 2]

In this case, h may be the encoded binary hologram profile, F may be a two-dimensional Fourier transform, T may be a tiling function (described below), fₓ may be a spatial frequency information in the x direction, f_{y} may be a spatial frequency information in the y direction, S may be a Sinc function, Pd may be a propagation function, and F⁻¹ may be a two-dimensional inverse Fourier transform.

The processor 112 may convert the encoded binary hologram profile h by using the two-dimensional Fourier transform into spatial frequency information.

The processor 112 may tile spatial frequency information by using a tiling function. In this case, the tiling function may be referred to as a function that copies and pastes variables as they are on both sides, and by tiling spatial frequency information, the pieces of high-order diffraction term noise generated by the diffraction grating may be modeled. According to an example embodiment, the processor 112 may tile spatial frequency information in a 3*3 matrix form by using a tiling function. However, the form of the tiled spatial frequency information is not limited thereto.

The processor 112 may adjust the spatial frequency information to have a physically proper energy distribution by using Formula 3 below.

S(fₓ,f_{y})=sinc(ppₓfₓ)sinc(ppₓf_{y}) [Formula 3]

In this case, ppₓ may be an interval between unit pixels of a binary phase spatial light modulator (SLM), fₓ may be the spatial frequency information in an x direction, and f_{y} may be the spatial frequency information in a y direction.

The processor 112 may calculate a propagation function value of the holographic image displayed on the display surface apart from the light modulation surface of the binary phase spatial light modulator SLM by a first distance d by using the propagation function of Formula 4 below.

$${P}_{d} ( {f}_{x} , {f}_{y} ) = \{ \begin{matrix}{e}^{- i \frac{2 π}{λ} d \sqrt{1 - {( λ {f}_{x} )}^{2} - {( λ {f}_{y} )}^{2}}} , & if \sqrt{{f}_{x}^{2} + {f}_{y}^{2}} < \frac{1}{λ} \\ 0 & otherwise\end{matrix} \qquad [ Formula 4 ]$$

In this case, d may be a propagation distance, A may be a center frequency of a used light beam, fₓ may be spatial frequency information in the x direction, and f_{y} may be spatial frequency information in the y direction.

In operation S50 of calculating the intensity I of the holographic image reproduced on the display surface, the processor 112 may calculate the intensity I of the reproduced holographic image by using Formula 5 below.

I=|z|² [Formula 5]

In this case, z may be a field value of the holographic image on the display surface.

In operation S60 of calculating the loss function value based on the difference between the intensity I of the holographic image reproduced on the display surface and the intensity I of the target image, the processor 112 may calculate the loss function value by using Formula 6 below.

L=Σ(I−Î)² [Formula 6]

In this case, I may be the intensity of the holographic image, and Î may be the intensity of the target image.

In operation S70 of updating the initial hologram profile based on the loss function value L, the processor 112 may update the hologram profile in a direction, in which the loss function (refer to Formula 6) decreases. The processor 112 according to an example embodiment may update the amplitude and phase of the hologram profile by using Formula 7 below.

$${A}_{v , n + 1} ← {A}_{v , n} - \frac{\partial L}{\partial ( {A}_{v , n} )} \\ {φ}_{v , n + 1} ← {φ}_{v , n} - \frac{\partial L}{\partial ( {φ}_{v , n} )} \qquad [ Formula 7 ]$$

In this case, φ_{v,n} may be a current phase profile, φ_{v,n+1} may be an updated phase profile, A_{v,n} may be a current amplitude profile, A_{v,n+1} may be an updated amplitude profile, and L may be a loss function.

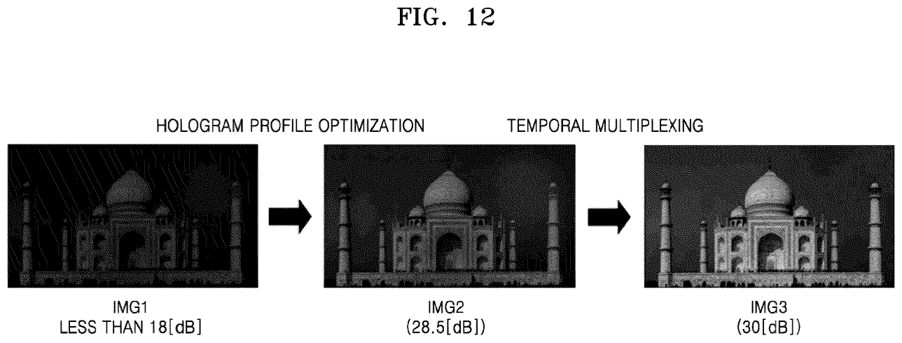

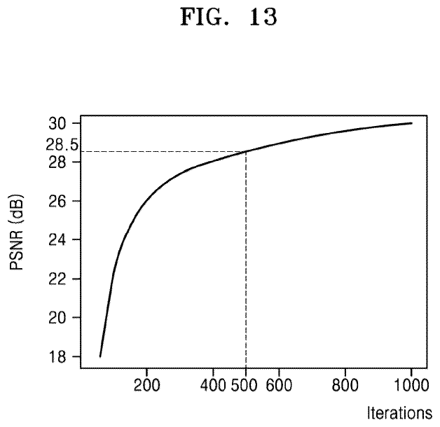

FIGS. 12 and 13 are diagrams for explaining the effects of a hologram profile optimization method and a time multiplexing method, respectively.

Simulation has been conducted to verify the effectiveness of the hologram profile optimization method and the time multiplexing method, and the parameters for an optical simulation have been designed as follows. To perform the hologram profile optimization method, a wavelength A of light has been set at about 520 nm, the number of pixels of an image has been set to about 1920*about 1080, a pixel interval ppx of the binary phase spatial light modulator SLM has been set to about 8 μm, the propagation distance d has been set to about 50 mm, and the number of optimization iterations has been set to about 500 times. In addition, for the time multiplexing method, it has been set to polymerize ten holographic images. In other words, ten holographic images generated by performing ten random phase modulations on one hologram profile calculated by using the hologram profile optimization method have been polymerized.

Referring to FIG. 12, a first image IMG1 may represent the intensity (refer to I in FIG. 8) of the holographic image generated according to the initial hologram profile (or, the first hologram profile), a second image IMG2 may represent an intensity of the holographic image generated according to the optimized hologram profile (or, the second hologram profile), and a third image IMG3 may represent an intensity of the holographic image generated by applying the time multiplexing method to the optimized hologram profile. In FIG. 12, for convenience of description, degrees of difference in pieces of noise (that is, the DC term noise, the high-order diffraction term noise, and the conjugate image noise) between the first through third images IMG1, IMG2, and IMG3 are expressed as a difference in light and dark. In other words, it may be understood that the degree of noise is more severe as the intensity of the image gets darker.

Referring to FIG. 13, the illustrated graph may represent the PSNR of a holographic image according to the number of hologram profile optimization iterations. When the hologram profile optimization method of the disclosure is not performed (that is, the number of optimizations is 0), the PSNR of the holographic image may be less than about 18 dB. On the other hand, it may be confirmed that the PSNR of the holographic image is improved to about 28.5 dB, in the case of performing the set number of optimizations of about 500 times.

In addition, the intensity of the restored holographic image (that is, the third image IMG3) (refer to I in FIG. 8) has been improved to about 30 dB, when ten holographic images generated by performing the random phase modulation ten times on one optimized hologram profile are polymerized (that is, the time multiplexing method has been applied). In this case, the intensity of the third image IMG3 may be substantially the same as the intensity of the target image.

In this manner, when the hologram profile optimization method and the temporal multiplexing method are applied, the optical noise filtering system (that is, the 2-f system) may be omitted from the holographic display device, and thus, the size of the entire system may be reduced.

A hologram profile optimization method and the hologram profile generation device according to embodiments may replace an optical noise filtering system, by encoding by using a differentiable binarization function at the time of generating the hologram profile and calculating a field value of the holographic image considering a high-order diffraction term.

The holographic display device according to embodiments may omit an optical noise filtering system, by applying the temporal multiplexing method and the hologram profile optimization method thereto.

Although the holographic display device and the hologram profile generation device according to the disclosure have been described with reference to embodiments illustrated in the drawings to aid understanding, this is merely an example, and those of skill in the art should understood that various modifications and uniform embodiments are possible therefrom. Therefore, the true technical protection scope of the disclosure should be determined by the following claims.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and their equivalents.

What is claimed is:

1. A hologram profile optimization method comprising:
setting a first hologram profile as a variable; and
performing an optimization cycle a predetermined number of times, wherein the optimization cycle comprises:
encoding the first hologram profile into a binary hologram profile by using an ApproxSign function;
calculating a field value of a holographic image on a display surface for the binary hologram profile, considering high-order diffraction term noise of the holographic image by using a tiling function;
calculating an intensity of the holographic image on the display surface;
calculating a loss function value based on a difference between the intensity of the holographic image and an intensity of a target image; and
updating the first hologram profile to a second hologram profile based on the loss function value.

2. The hologram profile optimization method of claim 1, wherein the encoding of the first hologram profile into the binary hologram profile comprises calculating the binary hologram profile by using Formula 1 below:
h=sign(Aᵥ cos(φᵥ)+eps) [Formula 1]
wherein Aᵥ is an initial amplitude profile, φᵥ is an initial phase profile, eps is a small value, and a sign function is the ApproxSign function.

3. The hologram profile optimization method of claim 1, wherein the calculating of the field value of the holographic image on the display surface for the binary hologram profile comprises:
converting the binary hologram profile into spatial frequency information by using a second-order Fourier transform, and
tiling the spatial frequency information by using the tiling function.

4. The hologram profile optimization method of claim 3, wherein the calculating of the field value of the holographic image on the display surface for the binary hologram profile comprises adjusting the spatial frequency information by using Formula 2 below so that physically proper energy distribution is obtained:
S(fₓ,f_{y})=sinc(ppₓfₓ)sinc(ppₓf_{y}) [Formula 2]
wherein ppₓ is an interval between unit pixels of a binary phase spatial optical modulator, fₓ is the spatial frequency information in an x direction, and f_{y} is the spatial frequency information in a y direction.

5. The hologram profile optimization method of claim 4, wherein the calculating of the field value of the holographic image on the display surface for the binary hologram profile comprises calculating a propagation function value of the holographic image by using Formula 3 below:
$${P}_{d} ( {f}_{x} , {f}_{y} ) = \{ \begin{matrix}{e}^{- i \frac{2 π}{λ} d \sqrt{1 - {( λ {f}_{x} )}^{2} - {( λ {f}_{y} )}^{2}}} , & if \sqrt{{f}_{x}^{2} + {f}_{y}^{2}} < \frac{1}{λ} \\ 0 & otherwise\end{matrix} \qquad [ Formula 3 ]$$
wherein d is a propagation distance, A is a center frequency of a used light beam, fₓ is the spatial frequency information in the x direction, and f_{y} is the spatial frequency information in the y direction.

6. The hologram profile optimization method of claim 1, wherein the calculating of the field value of the holographic image on the display surface for the binary hologram profile comprises calculating the field value of the holographic image by using Formula 4 below:
z=p⁻¹(P_{d}(fₓ,f_{y})S(fₓ,f_{y})T(F(h)) [Formula 4]
wherein h is the encoded binary hologram profile, F is a two-dimensional Fourier transform, T is the tiling function, fₓ is spatial frequency information in an x direction, f_{y} is the spatial frequency information in a y direction, S is a sinc function, Pd is a propagation function, and F⁻¹ is a two-dimensional inverse Fourier transform.

7. The hologram profile optimization method of claim 6, wherein the calculating of the intensity of the holographic image on the display surface comprises calculating the intensity of the holographic image by using Formula 5 below:
I=|z|² [Formula 5]
wherein z is the field value of the holographic image on the display surface.

8. The hologram profile optimization method of claim 7, wherein the calculating the loss function value based on the difference between the intensity of the holographic image and the intensity of the target image comprises calculating the loss function value by using Formula 6 below:
L=Σ(I−Î)² [Formula 6]
wherein I is the intensity of the holographic image, and Î is the intensity of the target image.

9. The hologram profile optimization method of claim 8, wherein the updating of the first hologram profile to the second hologram profile based on the loss function value comprises updating the first hologram profile to the second hologram profile by using Formula 7 below:
$${A}_{v , n + 1} ← {A}_{v , n} - \frac{\partial L}{\partial ( {A}_{v , n} )} \\ {φ}_{v , n + 1} ← {φ}_{v , n} - \frac{\partial L}{\partial ( {φ}_{v , n} )} \qquad [ Formula 7 ]$$
wherein φ_{v,n} is a current phase profile, φ_{v,n+1} is an updated phase profile, A_{v,n} is a current amplitude profile, A_{v,n+1} is an updated amplitude profile, and L is a loss function.

10. A hologram profile generation device comprising:
a processor configured to generate a hologram profile by using a hologram profile optimization method;
a memory configured to store the hologram profile generated by the processor; and
a user interface configured to receive an instruction of a user and display a usage state,
wherein the hologram profile optimization method comprises:
setting a first hologram profile as a variable; and
performing an optimization cycle a predetermined number of times, wherein the optimization cycle comprises:
encoding the first hologram profile into a binary hologram profile by using an ApproxSign function;
calculating a field value of a holographic image on a display surface for the binary hologram profile, considering high-order diffraction term noise of the holographic image by using a tiling function;
calculating an intensity of the holographic image on the display surface;
calculating a loss function value based on a difference between the intensity of the holographic image and an intensity of a target image; and
updating the first hologram profile to a second hologram profile based on the loss function value.

11. The hologram profile generation device of claim 10, wherein the encoding of the first hologram profile into the binary hologram profile comprises calculating the binary hologram profile by using Formula 1 below:
h=sign(Aᵥ cos(φᵥ)+eps) [Formula 1]
wherein Aᵥ is an initial amplitude profile, φᵥ is an initial phase profile, eps is a small value, and a sign function is the ApproxSign function.

12. The hologram profile generation device of claim 10, wherein the calculating of the field value of the holographic image on the display surface for the binary hologram profile comprises:
converting the binary hologram profile into spatial frequency information by using a second-order Fourier transform; and
tiling the spatial frequency information by using the tiling function.

13. The hologram profile generation device of claim 12, wherein the calculating of the field value of the holographic image on the display surface for the binary hologram profile comprises adjusting the spatial frequency information by using Formula 2 below so that physically proper energy distribution is obtained:
S(fₓ,f_{y})=sinc(ppₓfₓ)sinc(ppₓf_{y}) [Formula 2]
wherein ppₓ is an interval between unit pixels of a binary phase spatial optical modulator, fₓ is the spatial frequency information in an x direction, and f_{y} is the spatial frequency information in a y direction.

14. The hologram profile generation device of claim 13, wherein the calculating of the field value of the holographic image on the display surface for the binary hologram profile comprises calculating a propagation function value of the holographic image by using Formula 3 below:
$${P}_{d} ( {f}_{x} , {f}_{y} ) = \{ \begin{matrix}{e}^{- i \frac{2 π}{λ} d \sqrt{1 - {( λ {f}_{x} )}^{2} - {( λ {f}_{y} )}^{2}}} , & if \sqrt{{f}_{x}^{2} + {f}_{y}^{2}} < \frac{1}{λ} \\ 0 & otherwise\end{matrix} \qquad [ Formula 3 ]$$
wherein d is a propagation distance, A is a center frequency of a used light beam, fₓ is the spatial frequency information in the x direction, and f_{y} is the spatial frequency information in the y direction.

15. The hologram profile generation device of claim 10, wherein the calculating of the field value of the holographic image on the display surface for the binary hologram profile comprises calculating the field value of the holographic image by using Formula 4 below:
z=p⁻¹(P_{d}(fₓ,f_{y})S(fₓ,f_{y})T(F(h)) [Formula 4]
wherein h is the encoded binary hologram profile, F is a two-dimensional Fourier transform, T is the tiling function, fₓ is spatial frequency information in the x direction, f_{y} is spatial frequency information in the y direction, S is a sinc function, Pd is a propagation function, and F⁻¹ is a two-dimensional inverse Fourier transform.

16. A holographic display device comprising:
a light source configured to provide light;
a spatial optical modulator configured to generate a holographic image by refracting the light; and
a processor configured to convert a first hologram profile to a second hologram profile by using a hologram profile optimization method, and provide the second hologram profile to the spatial optical modulator,
wherein the hologram profile optimization method comprises:
setting the first hologram profile as a variable; and
performing an optimization cycle a predetermined number of times, wherein the optimization cycle comprises:
encoding the first hologram profile into a binary hologram profile by using an ApproxSign function;
calculating a field value of the holographic image on a display surface for the binary hologram profile, considering high-order diffraction term noise of the holographic image by using a tiling function;
calculating an intensity of the holographic image on the display surface;
calculating a loss function value based on a difference between the intensity of the holographic image and an intensity of a target image; and
updating the first hologram profile to the second hologram profile based on the loss function value.

17. The holographic display device of claim 16, wherein the spatial optical modulator comprises a binary phase spatial optical modulator.

18. The holographic display device of claim 16, wherein the processor polymerizes a plurality of holographic images generated by performing a plurality of random phase modulations on the second hologram profile.

19. The holographic display device of claim 16, wherein the encoding of the first hologram profile into the binary hologram profile comprises calculating the binary hologram profile by using Formula 1 below:
h=sign(Aᵥ cos(φᵥ)+eps) [Formula 1]
wherein Aᵥ is an initial amplitude profile, φᵥ is an initial phase profile, eps is a small value, and a sign function is the ApproxSign function.

20. The holographic display device of claim 16, wherein the calculating of the field value of the holographic image on the display surface for the binary hologram profile comprises:
converting the binary hologram profile into spatial frequency information by using a second-order Fourier transform; and
tiling the spatial frequency information by using the tiling function.

21. The holographic display device of claim 20, wherein the calculating of the field value of the holographic image on the display surface for the binary hologram profile comprises adjusting the spatial frequency information by using Formula 2 below so that physically proper energy distribution is obtained:
S(fₓ,f_{y})=sinc(ppₓfₓ)sinc(ppₓf_{y}) [Formula 2]
wherein ppₓ is an interval between unit pixels of a binary phase spatial optical modulator, fₓ is the spatial frequency information in an x direction, and f_{y} is the spatial frequency information in a y direction.

22. The holographic display device of claim 21, wherein the calculating of the field value of the holographic image on the display surface for the binary hologram profile comprises calculating a propagation function value of the holographic image by using Formula 3 below:
$${P}_{d} ( {f}_{x} , {f}_{y} ) = \{ \begin{matrix}{e}^{- i \frac{2 π}{λ} d \sqrt{1 - {( λ {f}_{x} )}^{2} - {( λ {f}_{y} )}^{2}}} , & if \sqrt{{f}_{x}^{2} + {f}_{y}^{2}} < \frac{1}{λ} \\ 0 & otherwise\end{matrix} \qquad [ Formula 3 ]$$
wherein d is a propagation distance, A is a center frequency of a used light beam, fₓ is the spatial frequency information in the x direction, and f_{y} is the spatial frequency information in the y direction.

23. The holographic display device of claim 16, wherein the calculating of the field value of the holographic image on the display surface for the binary hologram profile comprises calculating the field value of the holographic image by using Formula 4 below:
z=p⁻¹(P_{d}(fₓ,f_{y})S(fₓ,f_{y})T(F(h)) [Formula 4]
wherein h is the encoded binary hologram profile, F is a two-dimensional Fourier transform, T is the tiling function, fₓ is the spatial frequency information in the x direction, f_{y} is the spatial frequency information in the y direction, S is a sinc function, Pd is a propagation function, and F⁻¹ is a two-dimensional inverse Fourier transform.
